(19) United States
(12) Patent Application Publication
(10) Pub. No.: US 2012/0297330 A1
(43) Pub. Date: Nov. 22, 2012

(54) Method and System for Generating Reports

(75) Inventors: Christian Meyers, San Francisco, CA (US); Jeffrey B. Rothman, Oakland, CA (US)

(73) Assignee: FLEXIGOAL INC., San Francisco, CA (US)

(21) Appl. No.: 13/474,018

(22) Filed: May 17, 2012

Related U.S. Application Data
(60) Provisional application No. 61/487,240, filed on May 17, 2011.

(51) Int. Cl. G06F 3/048

(52) U.S. Cl. 715/772

(57) ABSTRACT

A computer implemented method is described for generating reports such as employee performance review reports. The method of the present invention assists a user in gathering and providing substantive content for reports. The present disclosure describes, as an embodiment of the present invention, a human resources application that assist in developing substantive content for employee performance reviews that can then be further used to manage employees.

### FIELD OF THE INVENTION

The present invention generally relates to the field of computerized software. More particularly, the present invention relates to computerized methods for generating reports.

### BACKGROUND OF THE INVENTION

Running a business can involve a lot of time and effort to address a company's products. But also important in running a business is its proper management. Important in this management are human resources especially in a growing company.

An important aspect of human resources administration is in the evaluation of employees. Through the evaluation of employees, valuable feedback is obtained by the company to address any issues. Likewise, the evaluation of employees provides valuable feedback to the employees themselves about their performance and how it can be improved. Many organizations see the value of this important type of feedback and seek to receive feedback in a timely way. Whereas some organizations perform yearly performance reviews, others attempt more frequent reviews.

Unfortunately, existing systems for evaluating employees can be labor intensive, cumbersome, and not user-friendly. Also, existing tools may not generate consistent results for every user. Although there may exist computer tools for evaluation of employees, such tools nonetheless put a large burden on the users to generate the content for employee reviews. Software applications tend to simply be sets of data entry forms. But people often do not know what to enter in such forms. People also tend not to do much with data they input and collect that may be relevant to the reports.

### SUMMARY OF THE INVENTION

There is, therefore, a need for computer software that does more real work for users by gathering and presenting substantive content for users. The present disclosure describes a human resources application that assists in developing substantive content for users and then assists them in managing employees. Those of ordinary skill in the art will understand, however, that the teachings of the present invention are applicable to many other fields.

There is also a need for computer software that does not rely upon keyboards for user interaction. Software is constrained by its most common access point—the traditional keyboard and screen setup. This constraint can seem unnatural and may severely limit the utility of software, especially now that data and software is readily stored on the internet (or the cloud) and is accessible from potentially anywhere in the world. Also, new mobile computing devices no longer limit computing to traditional offices. The present disclosure describes a system where users are able to interact with software via touch, gesture, voice and other means of signaling.

These and other aspects of the invention will be better appreciated upon an understanding of the detailed description below.

### BRIEF DESCRIPTION OF THE DRAWINGS

The following drawings will be used to more fully describe embodiments of the present invention.

FIG. 1 is a block diagram of a system on which the methods of the present invention may be implemented.

FIG. 2 is a flowchart of a method according to an embodiment of the present invention.

FIGS. 3-14 are screenshots of certain steps of embodiments of the present invention.

### DETAILED DESCRIPTION OF THE INVENTION

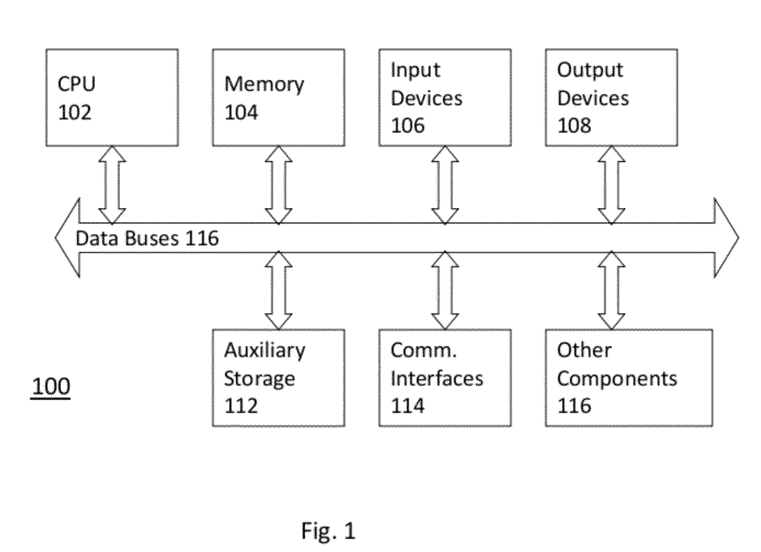

Among other things, the present invention relates to methods, techniques, and algorithms that are intended to be implemented in a digital computer system 100 such as generally shown in FIG. 1. Such a digital computer or embedded device is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), touch screen, voice driven input, eye motion tracker, or thought analyzer.

Communications interfaces 114 also form an important aspect of computer system 100 especially where computer system 100 is deployed as a distributed computer system. Computer interfaces 114 may include LAN network adapters, WAN network adapters, wireless interfaces (e.g., WiFi), Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available. Moreover, the present invention may be implemented on one or more distributed computers. Still further, the present invention may be implemented in various types of software languages including C, C++, Java virtual machine based languages, client-side languages such as JavaScript, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein, but it is understood that one of ordinary skill in the art would be familiar with such details.

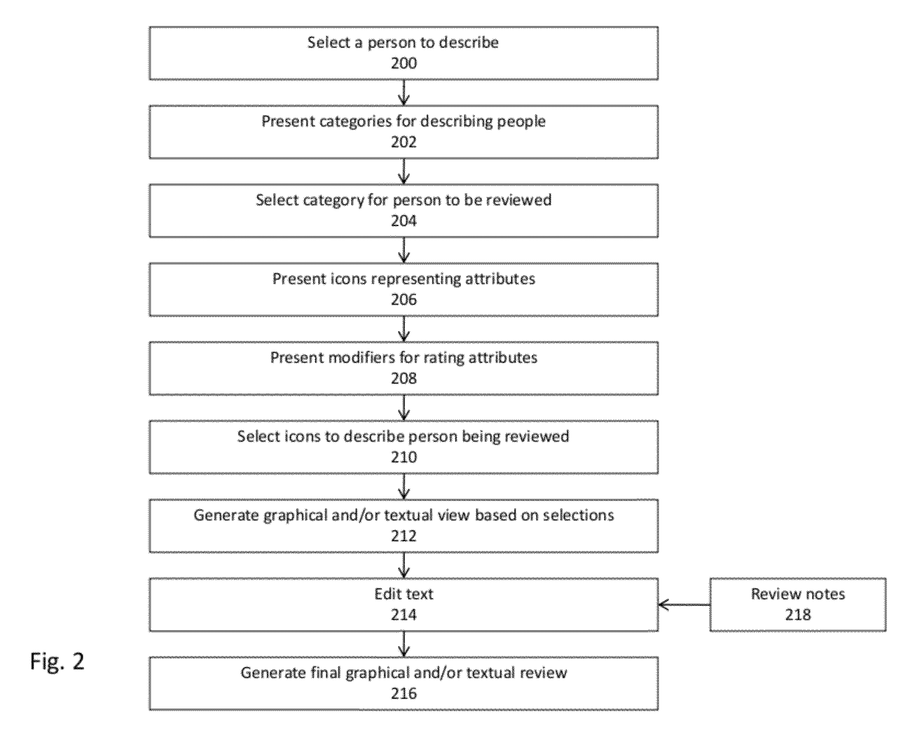

Shown in FIG. 2 is a flowchart for a method according to an embodiment of the present invention. Certain details will be described with reference to FIG. 2, but it should be understood that the breadth of the present invention is not limited to those details described with reference to FIG. 2. Instead, the breadth of the present application is to be measured by the scope of the claims.

As shown at step 200, a method according to an embodiment of the present invention presents at least one person to be described. For example, a listing of employees may be presented. The present invention, however, is not limited to people. In another embodiment of the invention, business entities, such as restaurants, can be described. In yet another embodiment of the present invention, products can be described.

At step 202, a method of the present invention presents categories for describing people. For example, the method of the present invention can be preconfigured to address certain types of employees such as software engineers, sales people, or marketers. With these or other predetermined categories of employees, certain other aspects of the present invention can also be preconfigured as will be described further below.

At step 204, a user selects a category for describing the person from the categories presented at step 202. The categories of steps 202 and 204 can, therefore, be dependent on the selection at step 200.

At step 206, the method of the present invention presents icons representing various attributes for describing the selected people. To increase the usability of the method of the present invention, the presented icons are preferably indicative of the associated attributes. For example, icons, images and avatars can be used to assist in denoting selections for business acumen or negotiating ability. At step 208, the method of the present invention presents modifiers (e.g., “needs improvement”, “successful”, “outstanding”) for the selections of step 206.

At step 210, a user selects a subset of icons (e.g., by dragging and dropping) to describe (rate) the person of interest. For example, icons can be provided to describe business acumen or negotiating ability. To make the selections, for example, a user may drag and drop icons in a rating category that stratifies the various selections.

At step 212, the method of the present invention generates a graphical and/or textual review based on icon selection and placement. The user can then edit the review at step 214. Also, at step 218, the user can select previously saved notes, images, and other media to be included in the generated report.

After the user is satisfied with his inputs at step 214, a method according to an embodiment of the present invention generates a final graphical and/or textual report such as for example, an employee performance review based on the user inputs and methods of the present invention.

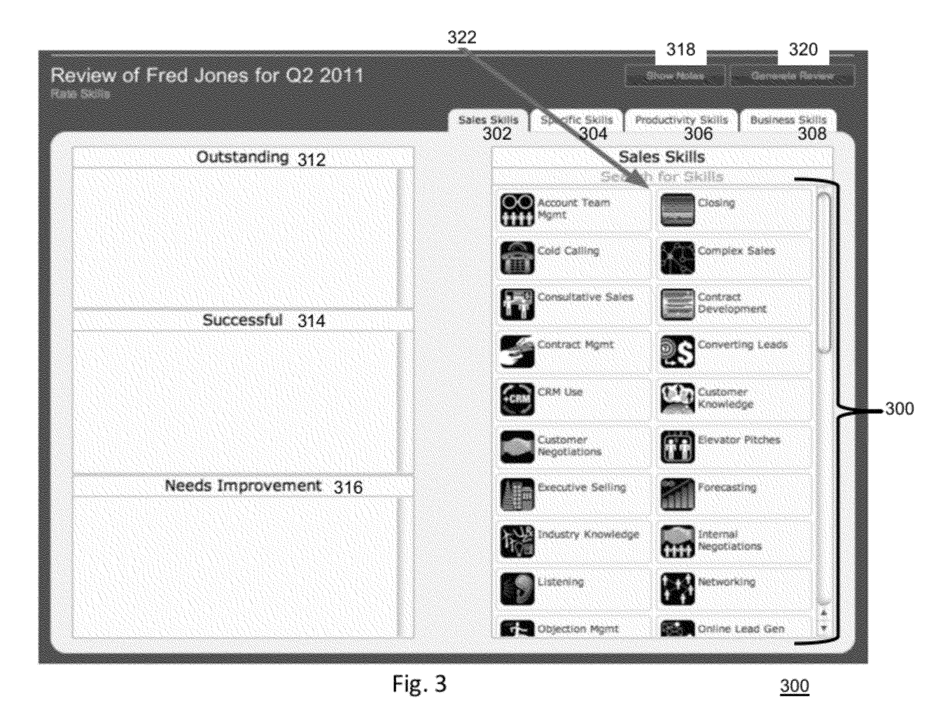

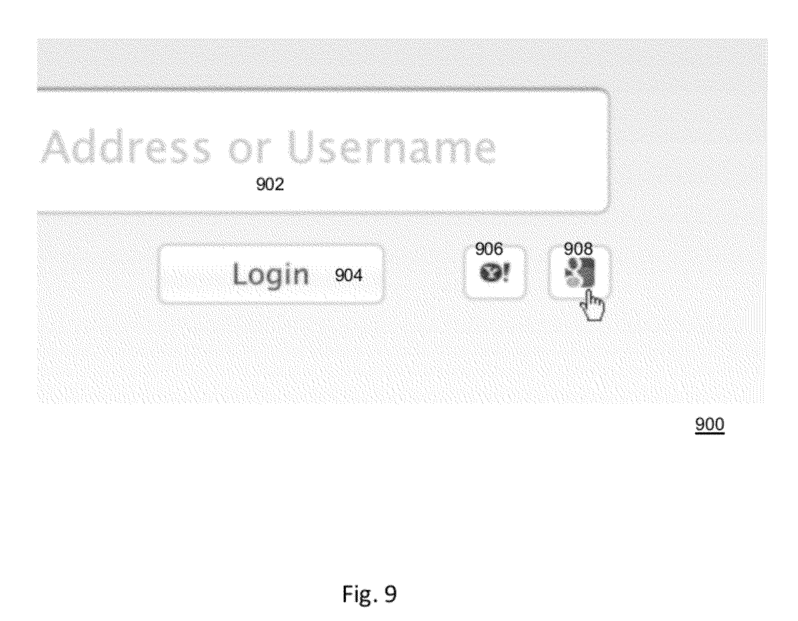

To be described now are certain implementation of steps of the present invention such as those described with reference to FIG. 2. More particularly, shown in FIGS. 3 through 18 are various screens shots for certain of the steps of the method of FIG. 2 that will be described for a full understanding of the present invention.

Shown in FIG. 3 is screenshot 300 that is used for generating a performance review for an employee named Fred Jones. Shown in FIG. 3 are various icons 302 representing various attributes for the employee of interest, Fred Jones. As shown in FIG. 3, Fred Jones is being reviewed as a sales person such that icons 302 for various sales skills are shown. For example, icon 322 is shown relating to “Closing” skills that may be considered important in evaluating a sales person. Shown in FIG. 3 are modifiers 312, 314, and 316 for rating the attributes of the selected icons 302 (e.g., outstanding, successful, or needs improvement, respectively). Also, shown in FIG. 3 are categories of skills 302 (Sales Skills), 304 (Specific Skills), 306 (Productivity Skills), and 308 (Business Skills) for the person being reviewed. Finally, for an embodiment of the present invention, icon 318 is provided so as to be able to review previously saved notes that may be applicable to the person being reviewed. Also, icon 320 is provided so that a report can be generated after completing the steps of FIG. 2, for example.

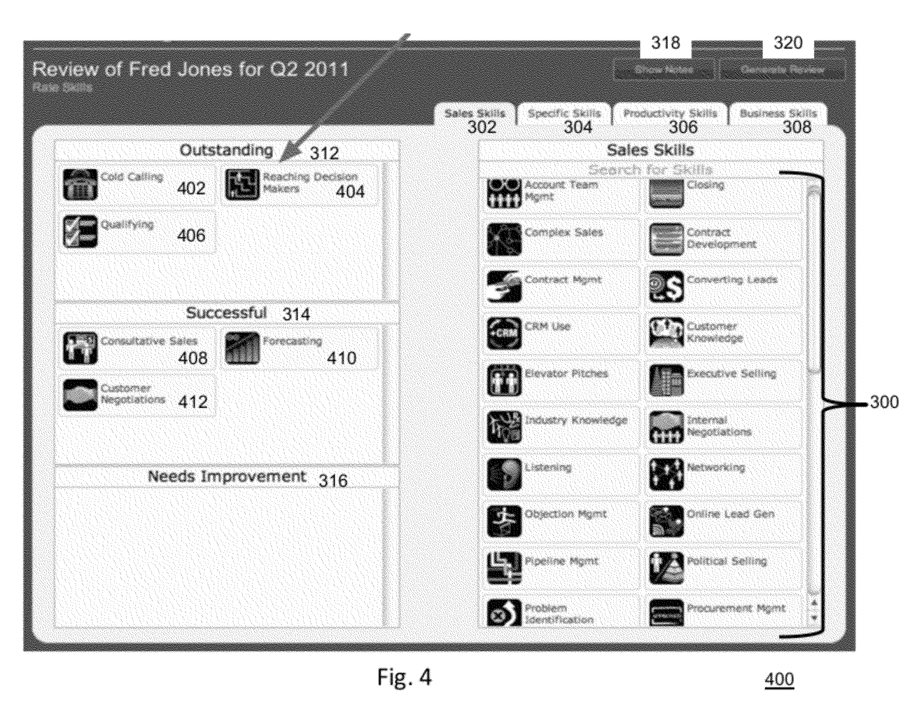

Shown in FIG. 4 are the results of the selection of certain of the icons that will be incorporated into a report for the employee of interest. Also shown is the rating of such skills into various categories. For example, in the outstanding category 312, icons 402 (Cold Calling), 404 (Reaching Decision Makers), and 406 (Qualifying) have been placed. In the successful category 314, icons 408 (Consultative Sales), 410 (Forecasting), and 412 (Customer Negotiations) have been placed. As further shown, at this time, no icons have been placed in needs improvement category 316 but could be added by simply dragging and dropping icons 300 into the needs improvement 316 category. Icons can also be deselected by dragging them back from 312, 314, or 316 into the non-rated icon pool 300.

As indicated in screenshot 400 for employee Fred Jones, he has outstanding skills in cold calling, qualifying, and reaching decision makers. He is also successful in consultative skills, customer negotiations, and forecasting. Nothing is indicated for needs improvement.

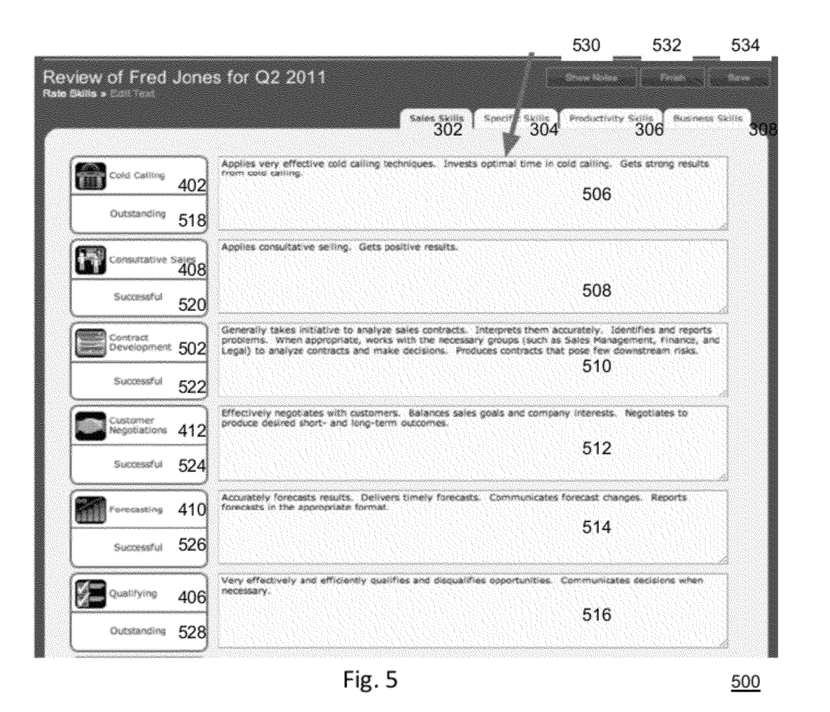

After completing a review, icon 320 can be selected to generate a review as shown in FIG. 5. As shown, for the various skills 402, 408, 502, 412, 410, 406, the rating attributes are shown (518, 520, 522, 524, 526, and 528, respectively). Also, for the various selected skills and indicated ratings, template descriptions are generated that are relevant to the person being reviewed (see descriptions 506, 508, 510, 512, 514, and 516, respectively). As shown, the template descriptions are relevant to a sales person, but one of ordinary skill in the art would understand that many more descriptions are possible. Likewise, one of ordinary skill in the art will understand that many other descriptions are possible for other persons or things being described.

Through the interface 500 as shown in FIG. 5, the descriptions (e.g., 506, 508, 510, 512, 514, and 516) can be edited and modified as desired for any particular person or thing being described. Indeed, the descriptions (e.g., 506, 508, 510, 512, 514, and 516) shown in FIG. 5 can be completely user generated or, in an embodiment, can be preconfigured text which a user can use as preconfigured or modify as necessary.

In an embodiment of the present invention, icon 530 (Show Notes) can be selected so as to review previously saved notes that may be relevant to the person or thing being reviewed. This embodiment is further described below. As a user is working on a report, icon 534 (Save) can be selected so as to periodically save the progress of the report. Upon completion of the report, icon 532 (Finish).

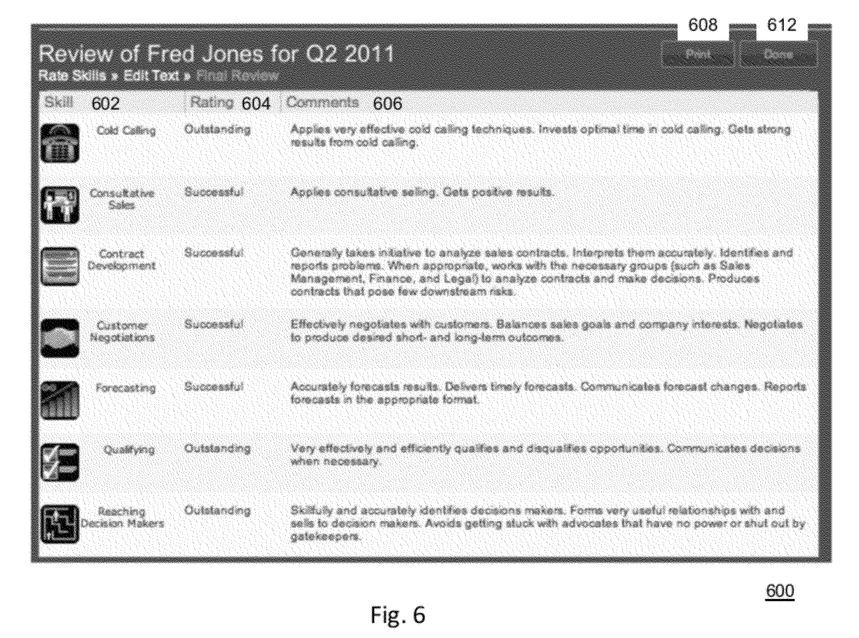

Shown in FIG. 6 is a completed report 600 that, in this case, is an employee review for Fred Jones. As shown, the method of the present invention provides a user friendly interface for displaying the skills that were rated as well as any associated comments. For example, in an embodiment, the final review is presented in tabular format with columns 602 (Skills), 604 (Rating), and 606 (Comments). In an embodiment of the invention, report 600 can be used as a tool for conducting a face-to-face review with the employee of interest. In another embodiment, different types of reports can be generated. For example, a reviewer report can be generated that contains information important to the reviewer and a reviewee report can be generated that may be more limited but that contains important information for the person being reviewed.

Thus, through the use of the present invention, generation of an employee review is facilitated. Also, the method of the present invention provides for a consistent manner of evaluating employees for predetermined skills for various job functions.

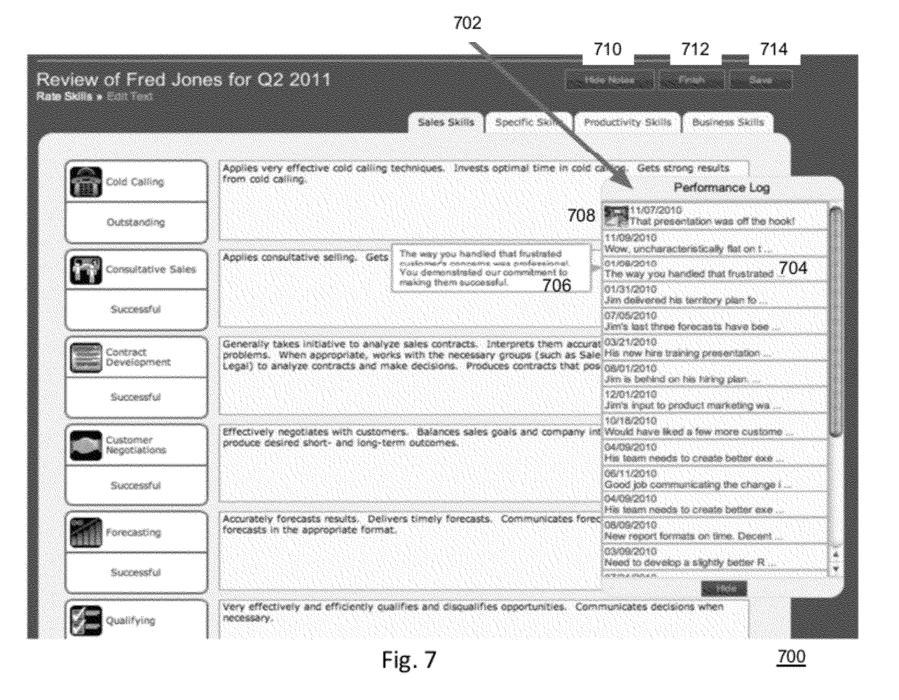

Shown in FIG. 7 is an implementation according to an embodiment of the present invention for making use of previously saved notes. Among other things, an embodiment of the present invention allows for inputting notes throughout a performance review period, for example, that can then be recalled at the time of generating the employee review. In this way, a user can be reminded of the various events throughout a review period that a user felt were relevant to the report. As shown in screenshot 700, notes are saved in a performance log 702. As shown, the notes range in dates from throughout the year 2010. As shown, textual information can be saved but so can other type of information. For example, shown as icon 708 is a note regarding an outstanding presentation. Linked to icon 708 is the presentation of interest. Files, images, and much other digital content can be noted in this way throughout a review period. As shown in FIG. 7, the various notes are limited in length as listed, but upon mousing over a note of interest, the full note can be shown (see, for example, partial note 704 and full note 706.

In an embodiment, the notes can be hidden by selecting icon 710, the report can be finished by selecting icon 712, and the report can be saved by selecting icon 714.

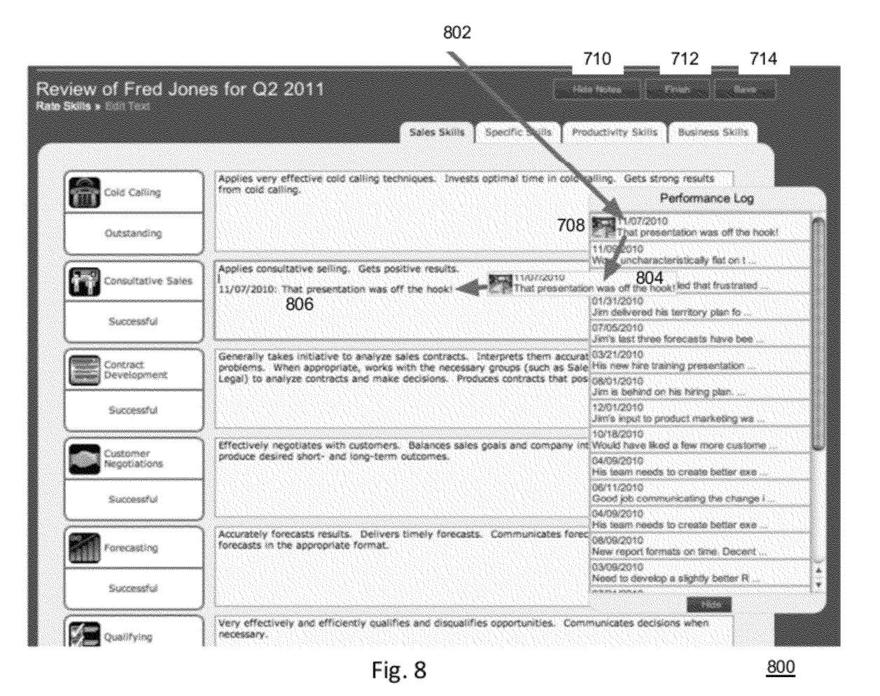

The displayed notes of FIG. 7 can be used or incorporated into the report 800 as shown in FIG. 8. For example, note 802 can be dragged and dropped into position 806. As user feedback, a ghost image 804 is shown so as to provide assurance that the correct icon has been selected. In an embodiment of the invention, the text of note 802 is placed into the comment field after which a user can edit the text as desired.

The present invention is not limited to standalone computers. Indeed, it is well suited for implementation on the Internet. Moreover, the present invention can be integrated into other online computer resources. For example, as shown in FIG. 900, screenshot 900 presents a user the ability to link a Yahoo (see icon 906) or Google (see icon 908) account with embodiments of the present invention. When so incorporated, associated usernames or addresses can be input into field 902. In a same or subsequent screen, a password can be entered.

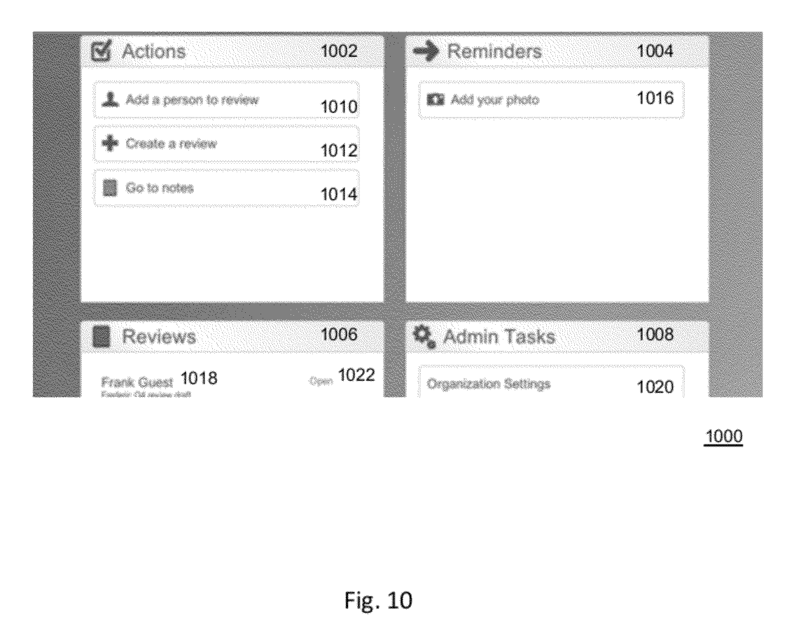

In an embodiment, upon logging in, a user can be presented with several options as shown in screenshot 1000 of FIG. 10. As shown, a user can take certain actions in section 1002. For example, he can be presented with reminders in section 1004. Also, he can be presented with options to perform certain reviews 1006 as well as the option to perform certain administrative tasks 1008. Actions 1002 include the ability to add a person to review 1010, create a review, 1012, and go to notes 1014. Reminders 1004 can include a reminder to add a photo 1016. Other reminders 1004 can include, among others, a reminder to add periodic notes. As shown, a review 1006 for Frank Guest 1018 is indicated as open 1022. A selection for Administrative tasks 1008 includes the option to modify settings for an organization 1020. Of course, the options shown in FIG. 10 are only exemplary. Many more options are possible as would be understood by one of ordinary skill in the art.

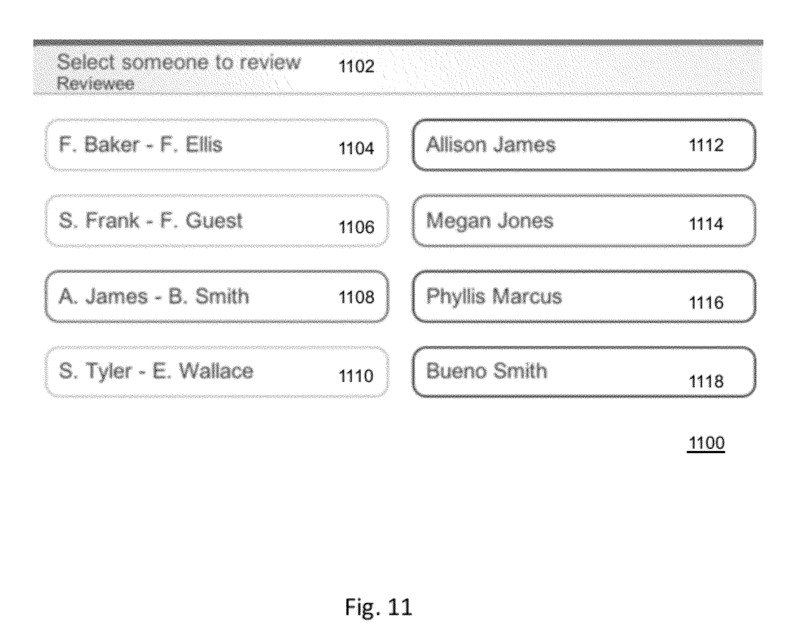

Shown in screenshot 1100 of FIG. 11 is a manner by which a Reviewee 1102 can be selected. As shown, a list of reviewees 1104-1118 is presented. A reviewee can then be selected by clicking on its associated icon. In an embodiment of the invention, the status of reviews for the various reviewees 1104-1118 can be indicated by predetermined colors. For example, a first color can be used for those reviews that have been completed. Likewise, reviews that have been completed can be indicated by a second predetermined color. Reviews that have been started but not completed can be shown by a third predetermined color. Other colors can be used for other purposes.

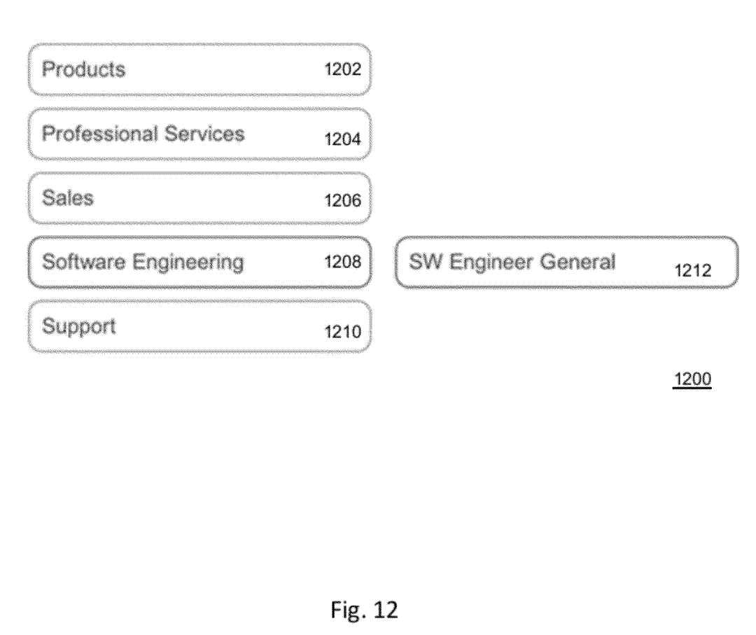

Shown in screenshot 1200 of FIG. 12 are categories for a person being reviewed such as a reviewee of FIG. 11. In an embodiment of the invention, the categories 1202-1212 shown in FIG. 12 are dependent on the reviewee that is selected. In another embodiment, the categories can be applicable to all reviewees. As shown in FIG. 12, a selection can be made by clicking on the icon associated with a category of interest.

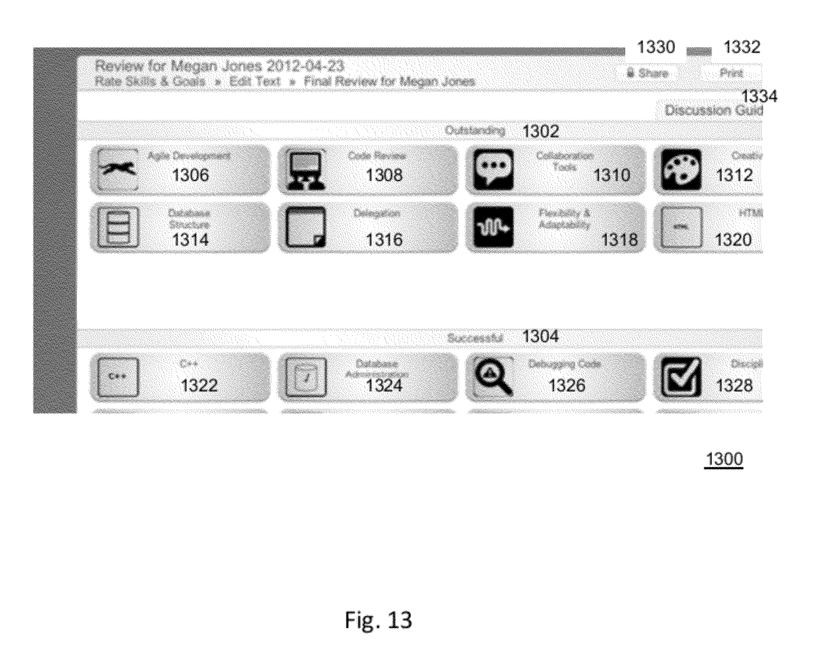

Shown as screenshot 1300 of FIG. 13 is an embodiment for summarizing reports generated through methods according to embodiments of the present invention. As shown, icon 1134 is selected to generate the report of FIG. 13 that is intended to be a graphical discussion guide when performing an in-person review. Rankings 1302 (Outstanding) and 1304 (Successful) are shown. Within ranking 1302 (Outstanding), icons 1306-1320 have been selected as corresponding to attributes that the person of interest performs in an outstanding way. Within ranking 1304 (Successful), icons 1322-1328 have been selected as corresponding to attributes that the person of interest performs in a successful way. In an embodiment of the invention, graphical images are associated with all the icons so as to readily associate the skill being ranked. For example, an icon of a cheetah is chosen for icon 1306 to associate the attribute “Agile Development.” In this way, the interface of screenshot 1300 can provide a useful discussion guide for initiating a conducting a performance review. In an embodiment of the present invention, the discussion guide can be printed by selecting icon 1332.

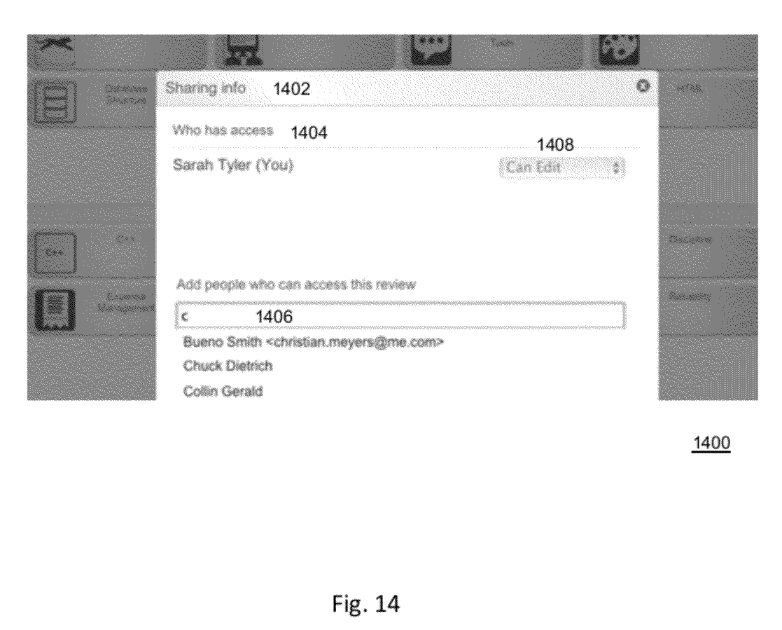

In an embodiment of the present invention, reports can be shared with others by selecting icon 1330, for example. Upon selection of icon 1330, screenshot 1400 as shown in FIG. 14 is presented. Sharing information 1402 can include, for example, a listing those individuals that have access (1404), the privileges 1408 of such individuals. Also, in an embodiment of the present invention, a field is made available for adding individuals (1406) with whom reviews can be shared.

It should be appreciated by those skilled in the art that the specific embodiments disclosed above may be readily utilized as a basis for modifying or designing other embodiments. For example, one of ordinary skill would readily understand that the present invention can be implemented in other passive station scenarios such as bus stations, toll booths, and ticket counters, among others. It should also be appreciated by those skilled in the art that such modifications do not depart from the scope of the invention as set forth in the appended claims.

What is claimed is:

1. A computer-implemented method for generating reports:
presenting user selectable categories for a subject of a report;
receiving input for at least one category for the subject of the report;
presenting user selectable icons corresponding to attributes of the user selectable categories;
receiving input for at least one icon;
presenting user selectable modifiers for the attributes;
receiving input for at least one modifier;
receiving text for any one of the at least one category, at least one icon, or at least one modifier; and
generating a report based on the received information for the subject of the report.

2. The computer-implemented method of claim 1, wherein the report is a text based report.

3. The computer-implemented method of claim 1, wherein the report is graphics based.

4. The computer-implemented method of claim 1, wherein receiving text includes retrieving previously stored text.

5. The computer implemented method of claim 1, wherein the user selectable icons include images associated with the attributes of the user selectable categories.

6. The computer implemented method of claim 1, wherein the user selectable icons can be dragged and dropped into a field associated with the user selectable modifiers for the attributes.

7. The computer implemented method of claim 1, wherein the subject of the report is a person.

8. The computer implemented method of claim 7, wherein the report is a performance review.

9. The computer implemented method of claim 1, wherein the subject of the report is an organization.

10. The computer implemented method of claim 1, further comprising sharing the report with at least one other individual.

11. A computer-readable medium including instructions that, when executed by a processing unit, cause the processing unit to generate a report, by performing the steps of:
presenting user selectable categories for a subject of a report;
receiving input for at least one category for the subject of the report;
presenting user selectable icons corresponding to attributes of the user selectable categories;
receiving input for at least one icon;
presenting user selectable modifiers for the attributes;
receiving input for at least one modifier;
receiving text for any one of the at least one category, at least one icon, or at least one modifier; and
generating a report based on the received information for the subject of the report.

12. The computer-readable medium of claim 11, wherein the report is a text based report.

13. The computer-readable medium of claim 11, wherein the report is graphics based.

14. The computer-readable medium of claim 11, wherein receiving text includes retrieving previously stored text.

15. The computer-readable medium of claim 11, wherein the user selectable icons include images associated with the attributes of the user selectable categories.

16. The computer-readable medium of claim 11, wherein the user selectable icons can be dragged and dropped into a field associated with the user selectable modifiers for the attributes.

17. The computer-readable medium of claim 11, wherein the subject of the report is a person.

18. The computer-readable medium of claim 17, wherein the report is a performance review.

19. The computer-readable medium of claim 11, wherein the subject of the report is an organization.

20. The computer-readable medium of claim 11, further comprising sharing the report with at least one other individual.

21. A computing device comprising:
a data bus;
a memory unit coupled to the data bus;
a processing unit coupled to the data bus and configured to
present user selectable categories for a subject of a report;
receive input for at least one category for the subject of the report;
present user selectable icons corresponding to attributes of the user selectable categories;
receive input for at least one icon;
present user selectable modifiers for the attributes;
receive input for at least one modifier;
receive text for any one of the at least one category, at least one icon, or at least one modifier; and
generate a report based on the received information for the subject of the report.
